(19) United States
(12) Patent Application Publication
(10) Pub. No.: US 2018/0029195 A1
(43) Pub. Date: Feb. 1, 2018

(54) BALL JOINT AND APPARATUS FOR HOLDING AN OBJECT

(71) Applicant: Jason Green, Mississauga (CA)

(72) Inventor: Jason Green, Mississauga (CA)

(21) Appl. No.: 15/654,161

(22) Filed: Jul. 19, 2017

Related U.S. Application Data
(60) Provisional application No. 62/367,883, filed on Jul. 28, 2016.

(51) Int. Cl. B25B 5/02; B25B 5/16

(52) U.S. Cl. CPC B25B 5/02; B25B 5/163

(57) ABSTRACT

A ball joint and clamping apparatus are described in which a ball structure of the ball joint has opposing planar faces in substantially parallel relation to one another. The ball structure of the joint enters or exits the cavity of a split socket structure of the joint when the opposed planar faces of the ball structure are aligned with a slot disposed on the split socket structure. When the opposed planar faces are not so aligned, the cavity of the split socket structure retains the ball structure in the joint. Numerous additional features are also described.

### TECHNICAL FIELD

The present invention relates to the field of ball joints, including ball joints used in apparatuses for holding an object in place.

### BACKGROUND

Ball joints are used in a wide variety of applications. A typical ball joint comprises a ball member that is received by a socket member. One disadvantage of conventional ball joints is the difficulty of providing a secure ball joint which can be easily separated, when desired.

An apparatus can be used to hold objects in place, for numerous purposes. One example is a printed circuit board (PCB), which must be held in place during assembly, soldering, or testing. Numerous other applications are possible.

In many cases, the apparatus holding the object is used to free up the hands of a user for other tasks. An apparatus that is adjustable to a wide range of positions is therefore desirable.

In some situations, it can be difficult to mount the object in the holding apparatus. For example, when mounting PCBs for testing purposes, it is often necessary to align the PCB with numerous test pins, which contact various portions of the PCB. Improper alignment can result in inconsistent test results and so repeated clamping and unclamping of the PCB can be problematic.

In addition, direct handling of the object can sometimes be undesirable. For example, PCBs are often sensitive to static electric discharges and so direct handling of the PCB should be avoided where possible. Numerous other applications exist in which repeated mounting and unmounting of the object is not desirable.

### SUMMARY OF THE INVENTION

The present invention includes several aspects.

Forming one aspect is an apparatus for holding an object. The apparatus has a gripping structure for holding the object and a ball and socket joint connected to the gripping structure. The ball and socket joint includes a ball structure having a pair of opposing planar faces in substantially parallel relation to one another, and a split socket structure having a cavity. The split socket structure further defines an elongate slot that permits passage of the ball structure into or out of the cavity when the opposing planar faces of the ball structure are aligned with the slot. The ball and socket joint is connected to the gripping structure at the ball structure or the split socket structure.

Another broad aspect of the invention is directed to a ball and socket joint for connecting a first and second member. The ball and socket joint includes a ball structure having a pair of opposing planar faces in substantially parallel relation to one another, and a split socket structure having a cavity. The split socket structure further defines an elongate slot that permits passage of the ball structure into or out of the cavity when the opposing planar faces of the ball structure are aligned with the slot.

Another broad aspect of the invention is directed to an improved ball structure for use in a ball and socket joint. The joint is of a type having a split socket structure defining a cavity. The split socket structure further defines an elongate slot of adjustable width. The slot is adjustable between a retention width less than the diameter of the ball structure and a release width greater than or equal to the diameter of the ball structure. The improvement in the ball structure is a pair of parallel, planar faces on the ball structure, configured to allow the ball structure to pass through the slot when the split socket structure defines the slot in the retention width.

Another broad aspect of the invention is directed to a method of assembling a ball and socket joint. The method includes aligning a ball structure having a pair of opposing planar faces in substantially parallel relation to one another with an elongate slot disposed in a split socket structure of the joint, inserting the ball structure through the elongate slot into a cavity in the split socket structure configured to retain the ball structure, and rotating the ball structure in the cavity to secure the ball structure in the cavity of the split socket structure. In some cases, the method may further include adjusting the width of the elongate slot to a retention width less than the diameter of the ball structure.

In another aspect, the split socket structure may define the slot as having a length greater than or equal to the diameter of the ball structure and a width that is adjustable between a retention width less than the diameter of the ball structure and a release width greater than or equal to the diameter of the ball structure. In some cases, the slot may be a channel bisecting the cavity of the split socket structure.

In a further aspect, the split socket structure may include a clamp that defines the slot. The clamp is moveable between: a first configuration that arrests rotation of the ball structure within the split socket structure; a second configuration that defines the slot at the retention width and permits passage of the ball structure into or out of the cavity when the opposing planar faces of the ball structure are aligned with the slot; and a third configuration that defines the slot at the release width.

In another aspect, the ball structure may include an arm projecting from the ball structure. In some cases, the arm may be substantially parallel to the opposing planar faces of the ball structure. Where present, the arm may also be connected to the gripping structure.

In another aspect, a wall of the cavity in the split socket structure may have a planar face which abuts the planar face of the cavity when the clamp is in the first configuration. In some cases, the ball structure may include an additional planar face which abuts the planar face of the cavity when the clamp is in the first configuration. The additional planar face may be normal to the opposing planar faces of the ball structure.

In another aspect, the apparatus may further include a base connected to the ball and socket joint, opposite the gripping portion. The base may include anchors for securing the base to a work surface.

Other aspects of the invention will become apparent upon a review of the following detailed description and the accompanying drawings, the latter being briefly described hereinafter.

### BRIEF DESCRIPTION OF THE DRAWINGS

FIG. 1 is a front perspective view of an apparatus according to an exemplary embodiment of the invention, in a first position.

FIG. 2 is an exploded view of the exemplary embodiment of FIG. 1, in rear perspective.

FIG. 3 is a rear perspective view of the exemplary embodiment of FIG. 1 in a second position.

FIG. 4 is a front perspective view of the exemplary embodiment of FIG. 4 in a third position.

FIG. 5 is a front perspective view of the exemplary embodiment of FIG. 4, in which the clamp is being removed from the base.

FIG. 6 is a front view of the exemplary embodiment in FIG. 5.

FIGS. 7-8 are front perspective views of the exemplary embodiment of FIG. 5, which further illustrate the removal of the gripping structure from the apparatus.

### DETAILED DESCRIPTION

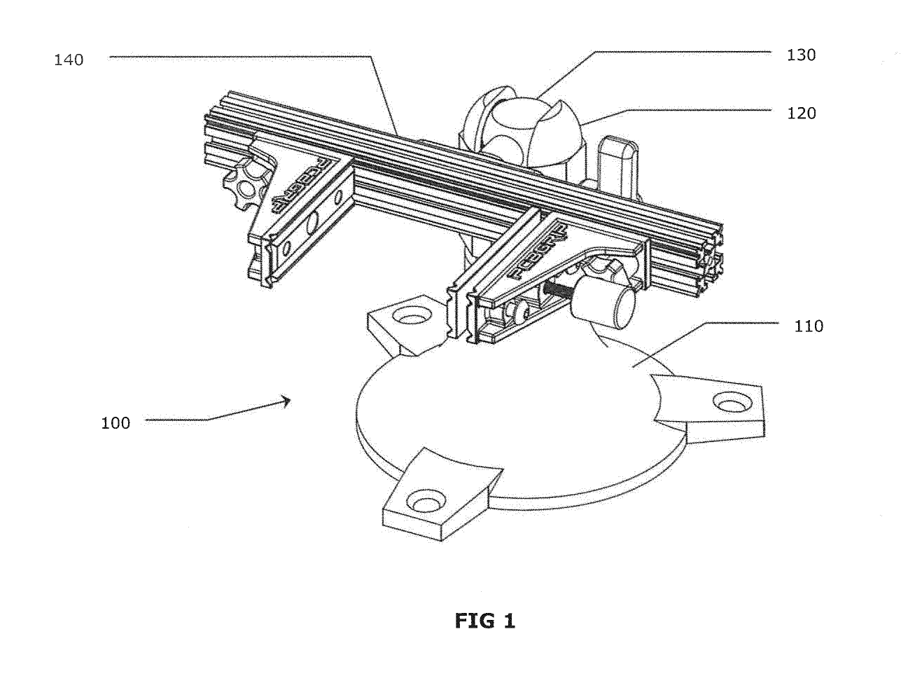

FIG. 1 shows an exemplary embodiment of an apparatus 100 according to one aspect of the invention. In this embodiment of the invention, the apparatus 100 comprises a base 110, a split socket structure 120, a ball structure 130, and a gripping structure 140. Whereas the drawings depict one particular embodiment, a number of variations are possible.

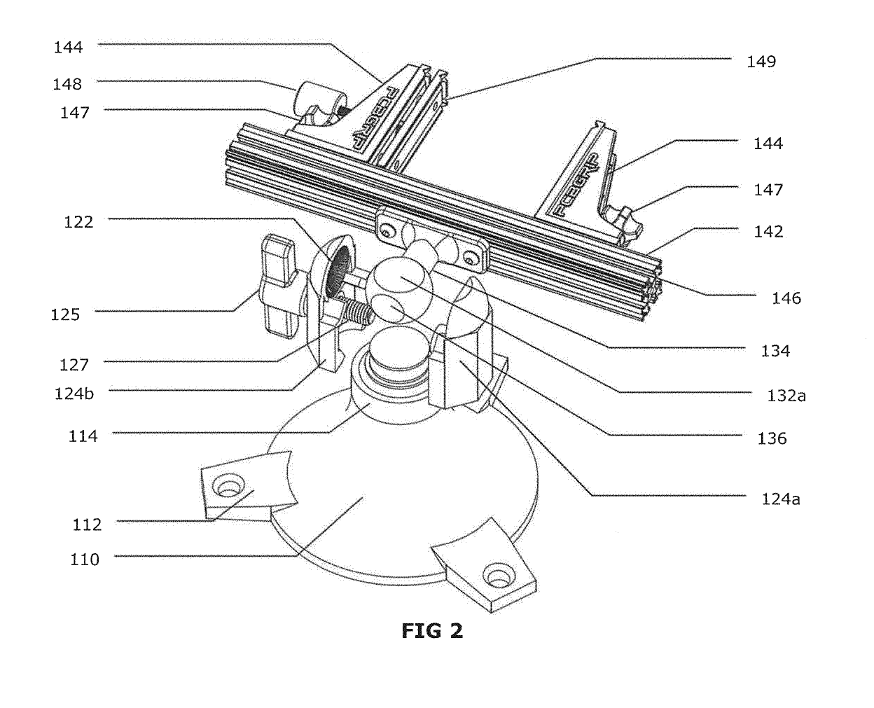

The gripping structure 140 holds an object of interest, which will depend on the specific application. In the embodiment shown in FIGS. 1-2, the object (not shown) is a printed circuit board (PCB), which is held in position by the apparatus 100 during soldering, assembly, testing, or other activities. A wide variety of other objects are contemplated within the scope of the present invention, including wood for woodworking, metal for metalworking, cell phones, or various other objects in need of holding.

Various configurations of the gripping structure 140 are contemplated within the scope of the invention. In the embodiment shown in FIG. 1, the gripping structure 140 comprises an extruded aluminum bar 142 with adjustable arms 144 at each end. The bar 142 includes a channel 146 through which the arms 144 can slide. A set of thumbscrews 147 allow the arms 144 to be locked at a desired position on the bar 142. Additional fine adjustments are also made possible in this embodiment by an adjustment knob 148, which moves an adjustment pad 149 toward the opposing arm 144.

Numerous other configurations are possible for the gripping structure 140. For example, the bar 142 could be a rod which passes through the arms 144, which bar 142 may or may not be threaded. Likewise, the spacing of the arms 144 may or may not be adjustable. A wide variety of suitable clamping configurations would be apparent to the person of skill having regard to the present specification, and all such configurations are contemplated within the scope of the present invention.

The ball structure 130 and split socket structure 120 cooperate to provide a ball and socket joint, which is attached to the gripping structure 140. In the embodiment show in FIGS. 1-2, the ball structure 130 is connected to the gripping structure 140. This configuration may also be reversed, with the split socket structure 120 being connected to the gripping structure 140. In the embodiment shown in FIGS. 1-2, the apparatus 100 also includes a base 110, to which the opposite end of the ball and socket joint is also connected. In some configurations of the invention, the base 110 may be omitted and/or the split socket structure 120 may itself serve as the base 110.

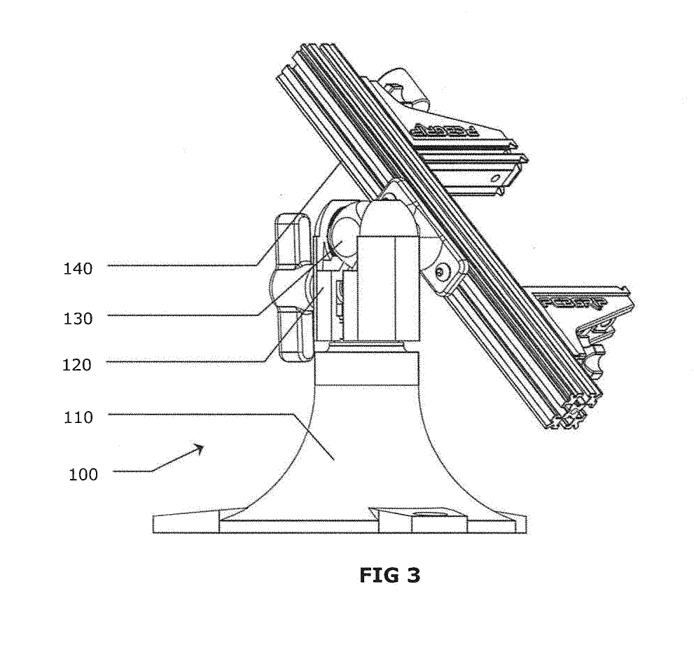

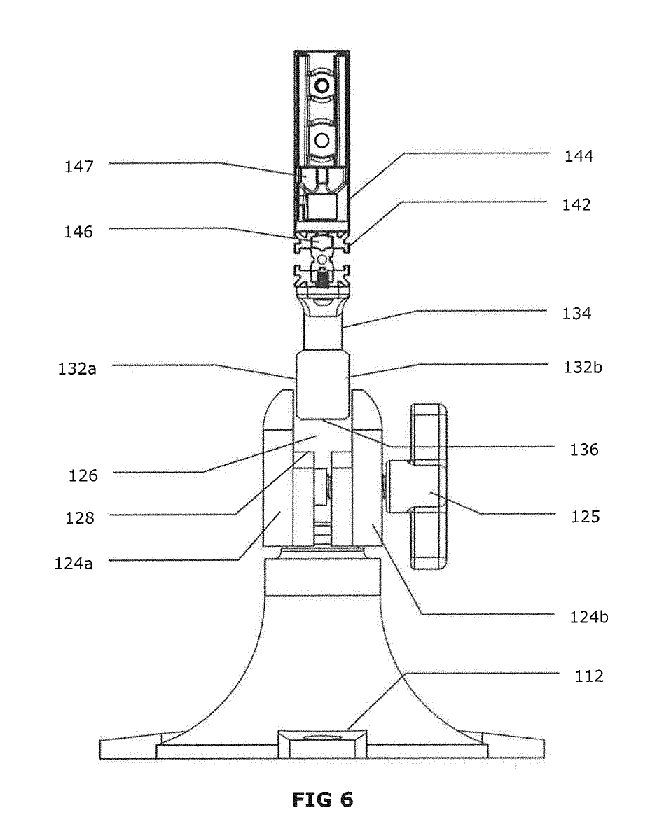

The ball structure 130 is substantially spherical, but includes two opposing planar faces 132a, 132b in substantially parallel relation to one another. An example of such a ball structure 130 can be seen in FIGS. 3-6. As seen in FIG. 3, the ball structure 130 rotates within the split socket structure 120. As seen in FIG. 6, the planar faces 132a, 132b allow the ball structure 130 to be removed when properly aligned with the split socket structure 120.

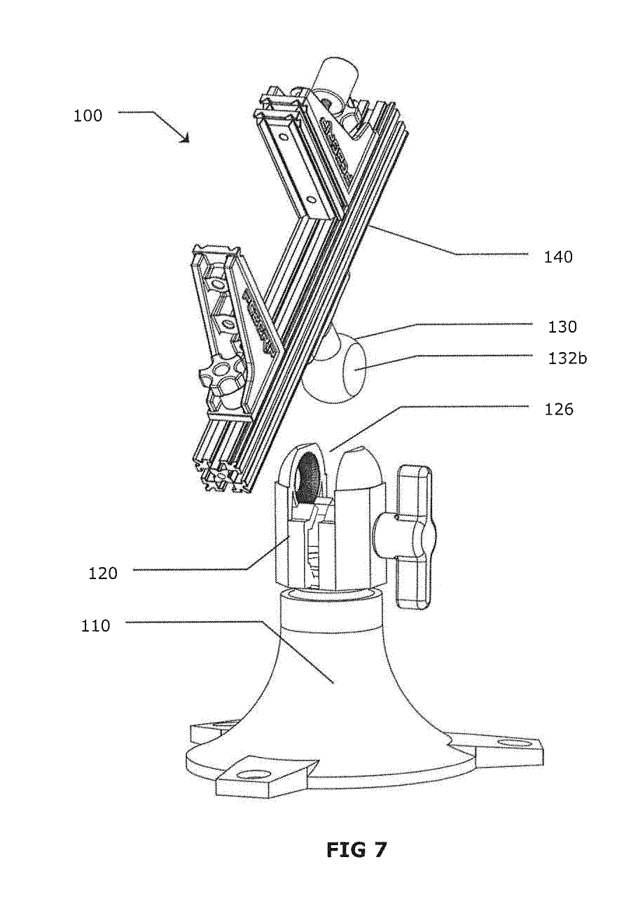

In the embodiment shown in FIGS. 1-8, the ball structure 130 includes an arm 134 which mediates the connection to the gripping structure 140. In other configurations of the invention, the arm 134 may mediate the connection to the base 110.

In the embodiment shown in FIG. 6, the arm 134 is substantially parallel with the opposing planar faces 132a, 132b, which facilitates insertion and removal of the ball structure 130 from the split socket structure 120. The arm 134 may also be positioned at an angle relative to the planar faces 132a, 132b, such as 30, 45, 60, or 90 degrees. In such angled configurations, it may be preferable to include a cooperating notch (not shown) in the split socket structure 120 to receive the arm 134.

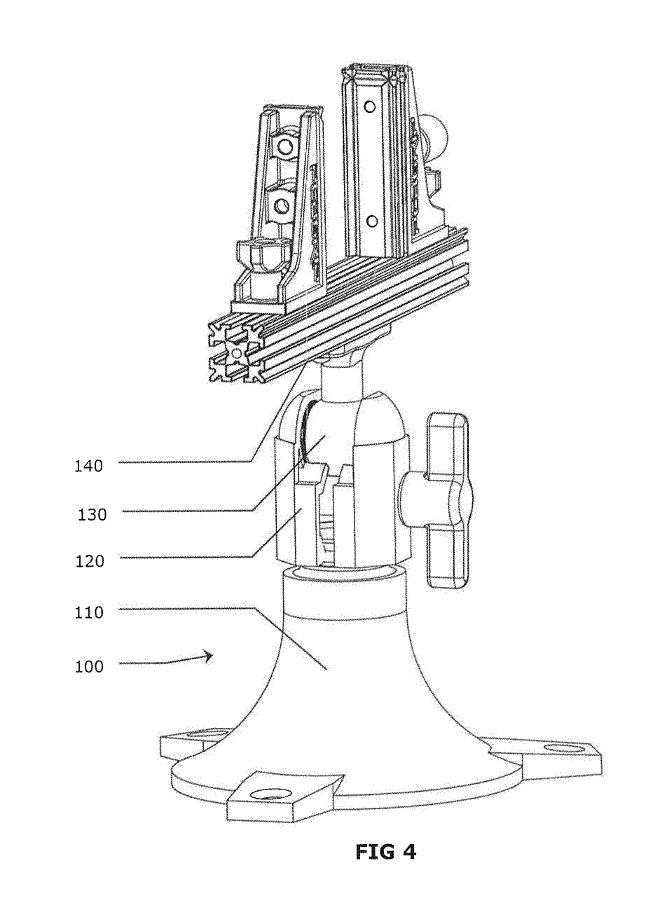

The split socket structure 120 includes a cavity 122, which receives the ball structure 130 when the joint is assembled. In at least one orientation, the cavity 122 retains the ball structure 130 in the joint (e.g. FIGS. 1-3). In at least one other orientation, the ball structure 130 may be removed from the cavity 122 (e.g. FIGS. 4-8), to disassemble the joint.

FIG. 2 provides an example of a cavity 122 according to the present invention. In this embodiment, the cavity 122 is defined by two opposing halves 124a, 124b of the split socket structure 120, which cooperate to define the cavity 122.

In the embodiment shown in FIG. 2, the use of opposing halves 124a, 124b allows the volume of the cavity 122 to be adjusted, using an adjustment knob 125 that turns a bolt 127 which joins the two halves 124a, 124b. This in turn allows the position of the ball structure 130 to be locked in place by tightening the knob 125, which creates a frictional fit between the ball structure 130 and the cavity 122 of the socket 120. The resulting configuration thus provides a clamp that selectively prevents rotation of the ball structure 130 within the socket structure 120.

In the example shown in FIG. 6, the cavity 122 also includes an optional planar surface 128 with which one or more faces of the ball structure 130 can cooperate to permit the apparatus 100 to be fixed in a predefined position. For example, in FIG. 4, the ball structure 130 includes an additional face 136 which abuts the surface 128 of the split socket structure 120 to provide a fixed vertical position for the apparatus 100. Similarly, the surface 128 of the split socket structure 120, when present, may also be configured to cooperate with the planar faces 132a, 132b of the ball structure 130, to provide fixed positions. For example, in FIGS. 1-2, planar face 132b abuts the surface 128 of the split socket structure to allow for a fixed horizontal position for the gripping structure 140.

The split socket structure 120 further includes a slot 126, through which the ball structure 130 passes when entering or exiting the cavity 122. The slot 126 is dimensioned so as to permit entry or exit of the ball structure 130 when the opposing planar faces 132a, 132b are aligned with the slot 126 (e.g. FIGS. 4-8) and deny such entry or exit when the opposing planar faces 132a, 132b are not so aligned (e.g. FIGS. 1-3).

In the embodiment shown in FIG. 1, the slot 126 has a length greater than or equal to the diameter of the ball structure 130 and a width that is adjustable between a first width less than the diameter of the ball structure 130 and a second width greater than or equal to the diameter of the ball structure 130.

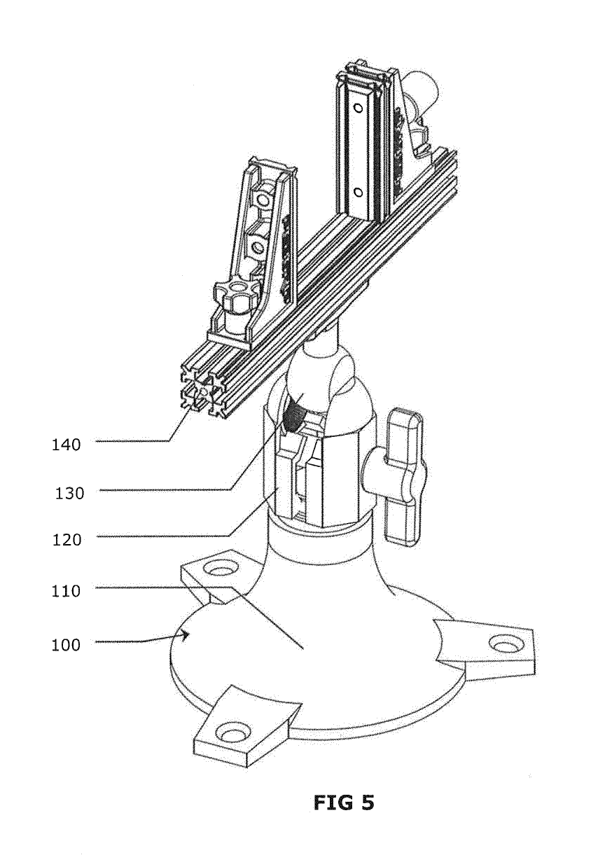

In the embodiment shown in FIGS. 5-6, the slot 126 extends through the entire split socket structure 120, so as to form a channel which bisects the cavity 122. Alternatively, the length of the slot 126 may be less than the diameter of the cavity 122, so as to provide a split socket structure 120 having side walls rather than a channel.

In some configurations, the dimensions of the slot 126 are adjustable. For example, in FIG. 6, the slot 126 is formed by opposing halves 124a, 124b of the split socket structure 120. Thus, adjustment of the spacing of the halves 124a, 124b using the adjustment knob 125 also adjusts the dimensions of the slot 126. This may permit the size of the slot 126 to be reduced so as to deny exit of the ball structure 130 from the cavity 122, when it is not desirable for the ball joint to be disassembled. Likewise, in some cases the slot 126 may be adjusted to a larger dimension to make it easier to align the opposing faces 132a, 132b of the ball structure 130 with the slot 126 when inserting or removing the ball structure 130 from the split socket structure 120.

Various configurations of the base 110 are contemplated, including those in which the base 110 is omitted or in which the split socket structure 120 acts as a base 110. In the embodiment shown in FIG. 1, the base 110 connects the split socket structure 120 to a work surface (not shown) using a plurality of anchors 112 through which fasteners, such as screws or bolts are inserted. The base 110 may also include an elongate stem 114, so as to raise the object up from the work surface to a desired height. In the apparatus 100 shown in FIG. 2, the stem 114 is relatively short and integrated with the base 110. The stem 114 may be an elongate rod with adjustment means for varying the height of the split socket structure 120 on the stem 114. Various other configurations would be apparent to the person of skill having regard to the present specification.

An apparatus 100 according to the present invention allows a user to selectively assemble and disassemble the ball joint, depending on operational needs. In use, the apparatus 100 allows the user to:
secure an object in the gripping structure 140;
hold the object in one or more working positions in which the ball structure 130 is retained in the split socket structure 120;
selectively disassemble the ball joint when desired by:
   moving the apparatus 100 to a disassembly position in which the opposing planar surfaces 132a, 132b of the ball structure 130 are aligned with the slot 126 in the split socket structure 120, and
withdrawing the ball structure 130 from the cavity 122 of the split socket structure 120; and
selectively assembly the ball joint by:
   aligning the opposing planar surfaces 132a, 132b of the ball structure 130 with the slot 126 in the split socket structure 120,
   inserting the ball structure 130 into the cavity 122 of the split socket structure, and
   moving the apparatus 100 into the one or more working positions.

An example of such selective disassembly can be seen in FIGS. 4-8. Assembly proceeds in much the same fashion, but in reverse order.

More generally, a ball joint according to the present invention allows the user to connect two objects by:
aligning a ball structure having opposing planar faces in substantially parallel relation to one another with an elongate slot disposed in a split socket structure of the joint;
inserting the ball structure through the slot into a cavity in the split socket structure configured to retain the ball structure; and
rotating the ball structure in the cavity to secure the ball structure in the cavity of the split socket structure.

In some configurations, this allows an object to be removed from a work surface, such as a work bench, without releasing the gripping structure 140 from the object. This may be helpful in situations where the act of mounting the object in the gripping portion is difficult or time-consuming. In configurations that include a base 110, this may also permit objects to be swapped out, by replacing a gripping structure 140 holding one object with a gripping structure 140 holding another object.

Likewise, assembling or disassembling the ball joint may be preferable to mounting or unmounting the object in applications where the alignment of the object in the gripping structure 140 is of particular importance. For example, when testing PCBs, the alignment of test pins in a testing rig with the contacts on the board must be precise in order to obtain consistent results. This is particularly important when the test rig is mounted on, or integrated with, the gripping structure 140 itself. Many other applications exist in which the alignment of the object in the gripping structure 140 is of particular relevance, such that it is desirable to minimize the need for clamping and unclamping of objects.

Various additional features described above provide additional functionality. For example, the use of one or more surfaces 128 in the embodiment shown in FIG. 6 allows the apparatus 100 to be configured for use in one or more pre-determined positions. Likewise, means to adjust the size of the cavity 122 can be used in some cases to create or release a frictional fit between the ball structure 130 and split socket structure 120. Similarly, means to adjust the size of the slot 126 can be used in some cases to permit or deny the disassembly or assembly of the ball joint.

Various materials and means of manufacture may be used to form an apparatus 100 according to the present invention. For example, the components of the apparatus 100 may be formed from molded plastics, to minimize costs. In other applications, the components may be formed by cast or milled metals, for increased durability. The choice of material and manufacturing method depends on the application in question, but would be readily apparent to the person of skill having regard to the present specification and so need not be discussed in detail here.

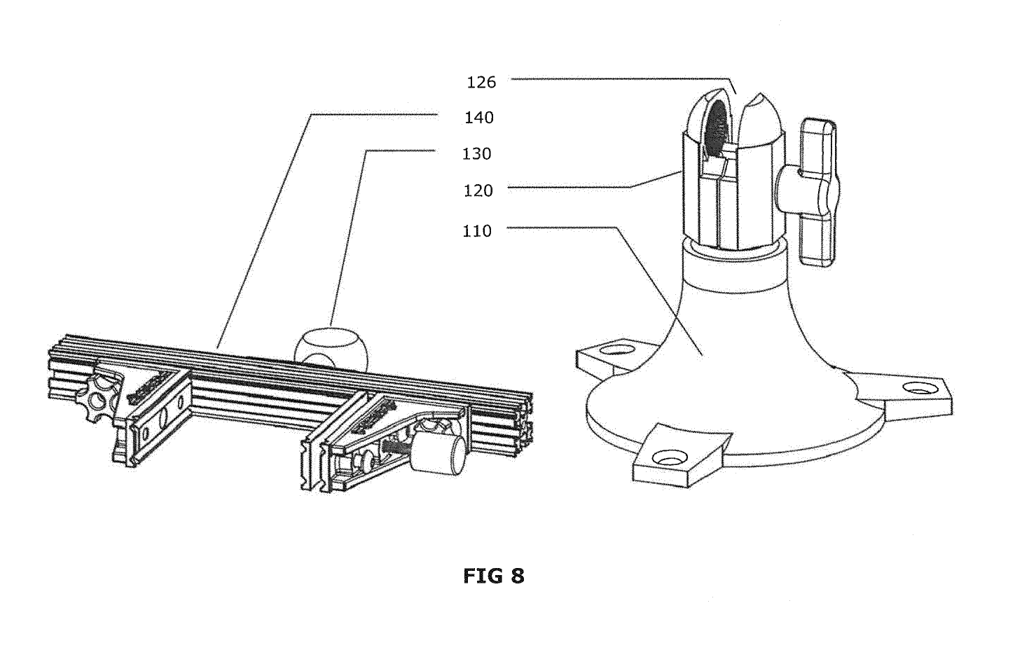

Persons of ordinary skill will readily appreciate several advantages:
For a ball and socket joint, the larger the diameter the ball, the greater the contact surface area between the ball and the socket, and therefore the heavier an object that can be held, as it is the contact surface area that creates the friction, and the holding power of the ball and socket joint is proportional to the surface area contact between the ball and socket. In the typical split socket design, as the socket is split, the ball is not in contact with the socket at the top or bottom of the socket. The socket only engages two opposing sides of the ball. With the ‘flat ball’, while the height of the ball (distance between the two parallel faces) is reduced, the curved portion of the flat ball that is in contact with the socket is not diminished and therefore the contact surface area is the same as a normal round ball and the holding power is not reduced.
when one needs steady hands to work, a good way to do so is to rest the hands on the bench. The flat ball allows a user to quickly remove the work from the socket and place it on the work surface, as shown in FIG. 8. Given the ball is flat and shorter than a normal ball, this gets the work closer to the work surface and therefore it makes it easier to steady the hands and what is held in the hands
the flat ball is faster to remove than a conventional round ball, since it is not necessary to fully open the socket

The embodiments of the present disclosure are intended to be examples only. Those of skill in the art may effect alterations, modifications and variations to the particular embodiments without departing from the intended scope of the present application.

Further, features from one or more of the above-described embodiments may be selected to create alternate embodiments comprised of a subcombination of features which may not be explicitly described above.

In addition, features from one or more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. The subject matter described herein and in the recited claims intends to cover and embrace all suitable changes in technology.

Accordingly, the invention should be understood to be limited only by the accompanying claims, purposively construed.

1. An apparatus for holding an object, the apparatus comprising:
a gripping structure for holding the object;
a ball and socket joint connected to the gripping structure, the joint comprising:
a ball structure having a pair of opposing planar faces in substantially parallel relation to one another, and
a split socket structure having a cavity, the split socket structure further defining an elongate slot that permits passage of the ball structure into or out of the cavity when the opposing planar faces of the ball structure are aligned with the slot;
wherein the joint is connected to the gripping structure at the ball structure or the split socket structure.

2. The apparatus of claim 1, wherein the split socket structure defines the slot as having a length greater than or equal to the diameter of the ball structure and a width that is adjustable between a retention width less than the diameter of the ball structure and a release width greater than or equal to the diameter of the ball structure.

3. The apparatus of claim 2, wherein the split socket structure comprises a clamp that defines the slot, the clamp having and being moveable between:
a first configuration that arrests rotation of the ball structure within the split socket structure;
a second configuration that defines the slot at the retention width and permits passage of the ball structure into or out of the cavity when the opposing planar faces of the ball structure are aligned with the slot; and
a third configuration that defines the slot at the release width.

4. The apparatus of claim 1, wherein the slot is a channel bisecting the cavity of the split socket structure.

5. The apparatus of claim 1, further comprising an arm projecting from the ball structure.

6. The apparatus of claim 5, wherein the arm is substantially parallel to the opposing planar faces of the ball structure.

7. The apparatus of claim 5, wherein the arm is connected to the gripping structure.

8. The apparatus of claim 3, wherein a wall of the cavity comprises a planar face that abuts an opposing planar face on the ball structure when the clamp is in the first configuration.

9. The apparatus of claim 3, wherein a wall of the cavity comprises a planar face and wherein the ball structure further comprises an additional planar face which abuts the planar face of the cavity when the clamp is in the first configuration.

10. The apparatus of claim 9, wherein the additional planar face is normal to the opposing planar faces of the ball structure.

11. The apparatus of claim 1, wherein the apparatus further comprises a base connected to the joint, opposite the gripping portion.

12. The apparatus of claim 11, wherein the base comprises anchors for securing the base to a work surface.

13. The apparatus 1, wherein the object is a printed circuit board.

14. A ball and socket joint for connecting a first and second member, the joint comprising:
a ball structure having a pair of opposing planar faces in substantially parallel relation to one another; and
a split socket structure having a cavity, the split socket structure further defining an elongate slot that permits passage of the ball structure into or out of the cavity when the opposing planar faces of the ball structure are aligned with the slot.

15. The joint of claim 14, wherein the split socket structure defines the slot as having a length greater than or equal to the diameter of the ball structure and a width that is adjustable between a retention width less than the diameter of the ball structure and a release width greater than or equal to the diameter of the ball structure.

16. The joint of claim 15, wherein the split socket structure comprises a clamp that defines the slot, the clamp having and being moveable between:
a first configuration that arrests rotation of the ball structure within the split socket structure;
a second configuration that defines the slot at the retention width and permits passage of the ball structure into or out of the cavity when the opposing planar faces of the ball structure are aligned with the slot; and
a third configuration that defines the slot at the release width.

17. The joint of claim 14, wherein the slot is a channel bisecting the cavity of the split socket structure.

18. The joint of claim 14, further comprising an arm projecting from the ball structure.

19. The joint of claim 18, wherein the arm is substantially parallel to the opposing planar faces of the ball structure.

20. The joint of claim 16, wherein a wall of the cavity comprises a planar face that abuts an opposing planar face on the ball structure when the clamp is in the first configuration.

21. The joint of claim 16, wherein a wall of the cavity comprises a planar face and wherein the ball structure further comprises an additional planar face which abuts the planar face of the cavity when the clamp is in the first configuration.

22. The joint of claim 21, wherein the additional planar face is normal to the opposing planar faces of the ball structure.

23. An improved ball structure for use in a ball and socket joint, the joint being of the type having a split socket structure defining a cavity, the split socket structure further defining an elongate slot of adjustable width, the slot being adjustable between a retention width less than the diameter of the ball structure and a release width greater than or equal to the diameter of the ball structure, the improvement in the ball structure comprising:
a pair of parallel, planar faces on the ball structure, configured to allow the ball structure to pass through the slot when the split socket structure defines the slot in the retention width.

24. The ball structure of claim 23, wherein the split socket structure comprises a clamp that defines the slot, the clamp having, and being moveable between:
a first configuration that arrests rotation of the ball structure within the split socket structure;
a second configuration that defines the slot at the retention width and permits passage of the ball structure into or out of the cavity when the opposing planar faces of the ball structure are aligned with the slot; and
a third configuration that defines the slot at the release width.

25. The ball structure of claim 23, further comprising an arm projecting from the ball structure.

26. The ball structure of claim 25, wherein the arm is substantially parallel to the opposing planar faces of the ball structure.

27. The ball structure of claim 24, wherein a wall of the cavity comprises a planar face that abuts an opposing planar face on the ball structure when the clamp is in the first configuration.

28. The ball structure of claim 24, wherein a wall of the cavity comprises a planar face and wherein the ball structure further comprises an additional planar face which abuts the planar face of the cavity when the clamp is in the first configuration.

29. The ball structure of claim 28, wherein the additional planar face is normal to the opposing planar faces of the ball structure.

30. A method of assembling a ball and socket joint, the method comprising:
aligning a ball structure having a pair of opposing planar faces in substantially parallel relation to one another with an elongate slot disposed in a split socket structure of the joint;
inserting the ball structure through the elongate slot into a cavity in the split socket structure configured to retain the ball structure; and
rotating the ball structure in the cavity to secure the ball structure in the cavity of the split socket structure.

31. The method of claim 30, further comprising the step of
adjusting the width of the elongate slot to a retention width less than the diameter of the ball structure.
